(19) United States
(12) Patent Application Publication
(10) Pub. No.: US 2003/0184438 A1
(43) Pub. Date: Oct. 2, 2003

(54) Sensor systems

(76) Inventors: Philip Elphee Williams, Dorset (GB); Peter John Jones, Dorset (GB)

Correspondence Address: Melvin I Stoltz, 51 Cherry Street, Milford, CT, 06460, US

(21) Appl. No.: 10/221,583

(22) PCT Filed: Mar. 15, 2001
(86) PCT No.: PCT/GB01/01153

(51) Int. Cl. G08B 13/08

(52) U.S. Cl. 340/545.2

(57) ABSTRACT

A sensor system for security purposes comprises a piezo-electric device (F) attached to a member (E) in the line of stress flux such that unauthorised movement of the member will result in deflection of the piezo-electric device and generation of an electrical output. The electrical output is passed to an electronic control circuit (H) which includes filter means (LPF) for separation of signals due to high-frequency events and is arranged to transmit a signal to an alarm.

### FIELD OF THE INVENTION

This invention relates to sensor systems.

The recent proliferation of “hole in the wall” cash dispensers or automatic teller machines, otherwise known as ATMs, has highlighted the need to provide some form of security device to warn against physical attacks by people intent on venting frustrations against the machine or, more importantly, attempting robbery.

In the majority of cases, the ATMs are located in banks or building societies but, in the future, it is likely that they will be found in less secure environments such as shopping centres, Post Offices, public houses and restaurants.

It is accordingly a specific object of the present invention to provide a sensor system which can be used to provide enhanced security for an ATM. It is a more general object of the present invention to provide an improved form of security system.

### SUMMARY OF THE INVENTION

According to a first aspect of the present invention there is provided a sensor system for security purposes, said sensor system comprising a piezo-electric device attached to a member in the line of stress flux such that unauthorised movement of the member will result in deflection of the piezo-electric device and generation of an electrical output which is passed to an electronic control circuit which includes filter means for separation of signals due to high-frequency events, which electronic control circuit is arranged to transmit a signal to an alarm, data processing device or other recording or indicating means.

The electronic control circuit is preferably arranged to respond to both low-frequency and high-frequency events.

The electronic control circuit may be arranged, in pre-selected circumstances, to generate a signal corresponding to an “ALERT” prior to generation of a signal corresponding to an “ALARM”.

The piezo-electric device preferably includes a disc or other suitably shaped piezo device which is bonded to the member which may be, for example, a panel of a safe, a panel of a housing of an ATM or a prefabricated bearer which is positioned so that any attempt to break down a wall or strong-room or to up-root a safe or an ATM will result in the application of stress to the prefabricated bearer and the generation of an output voltage.

The output voltage will be generated during the period when the piezo-electric device is subject to changes in its physical conditions. During the periods when a steady mechanical state is experienced, the output of the piezo-electric device will remain high until the device is discharged in much the same way as a capacitor behaves.

It is a characteristic of the piezo-electric device that the polarity of the generated signal reverses when the direction of deflection reverses so that it is possible to determine the direction of deflection should it be desirable to do so.

The piezo-electric device may be bonded to the member in a deflected condition. Bonding of the piezo-electric device to the member may be effected, for example, using a quick-drying adhesive such as a cyanoacrylate adhesive.

According to a second aspect of the present invention there is provided a security system which includes a sensor system as defined above, an electronic control or processing circuit and an alarm.

The security system will be of general application, though developed for ATMs, and may be used for the protection of safety deposit boxes, secure areas or equipment such as computers and the like.

### BRIEF DESCRIPTION OF THE DRAWINGS

FIG. 1 is a diagrammatic perspective view of a safe,

FIG. 2 shows the safe fitted with a sensor system,

FIG. 3 shows an automatic teller machine fitted with a sensor system,

FIG. 4 shows a wall or other barrier fitted with a sensor system,

FIG. 5 shows the lines of stress of the hinges of the safe shown in FIGS. 1 and 2, and

FIG. 6 shows the control circuit of the security system.

### DESCRIPTION OF THE PREFERRED EMBODIMENTS

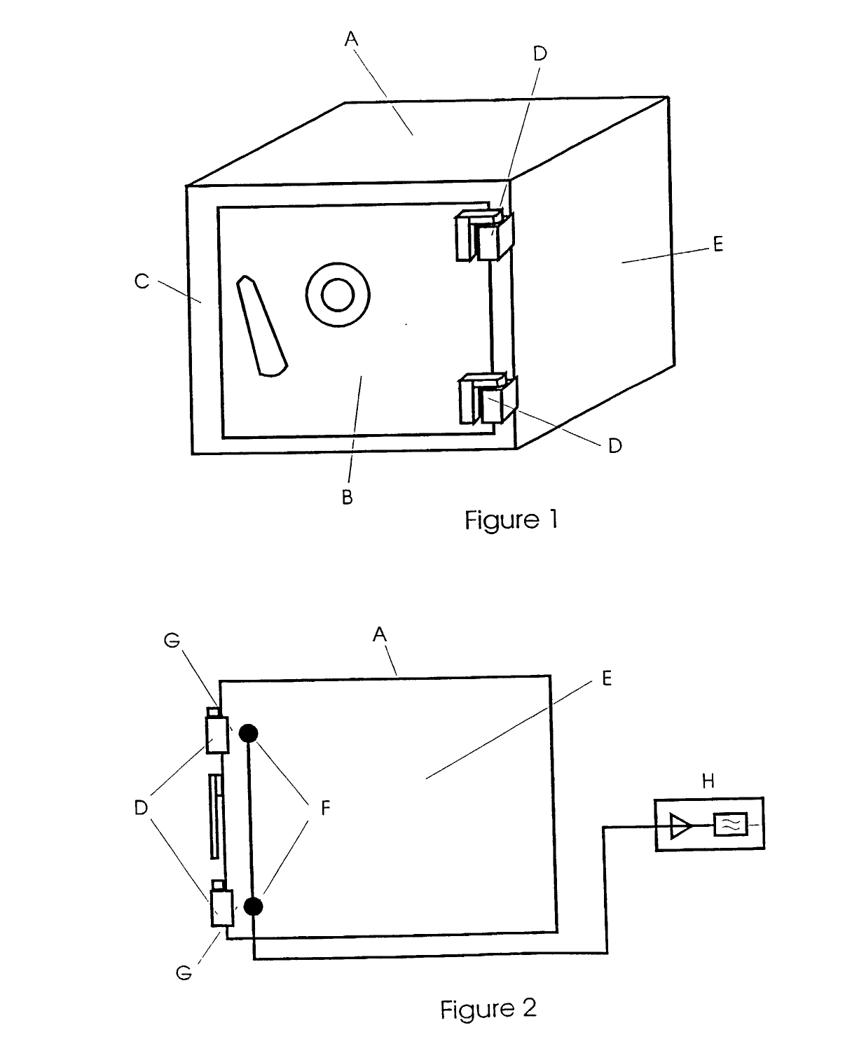

The safe A shown in FIG. 1 is typically made from steel and includes a door B and a side panel E on which the door B is hung by means of hinges D.

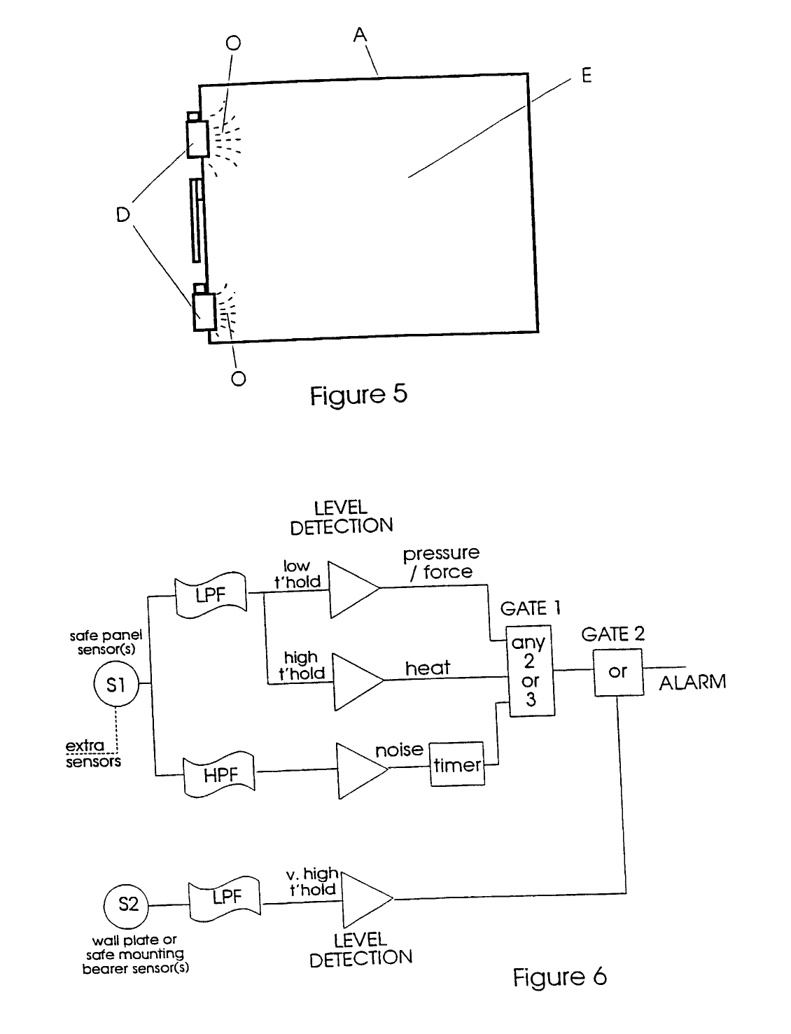

FIG. 2 of the drawings shows the side panel E and the hinges D while FIG. 5 of the drawings shows the lines of stress in the safe hinges and surrounding areas of the side panel E when an attempt is made to open the door B by, for example, inserting a crowbar or like implement between the wall of the safe and the door B at a point C.

Sensors F, in the form of disc-shaped (or other suitably shaped) piezo-electric devices, are attached at points G to the side panel E because it is at these points that the maximum deflection will take place in the event of someone attempting to force open the door B of the safe A. The energy required to force open the door will be transferred through the hinges D to the side panel E and focused at points G. Thus, if a crowbar or other implement is applied at point C, any attempt to force open the door B will set off the alarm due to deflection of the side of the safe A at one of the points G. Although FIG. 2 shows the fitting of two sensors F, i.e. one in line with each of the hinge points, in practice it may be sufficient to fit just one sensor F.

Additional sensors F can be fitted at other points on the side panel E which are considered vulnerable to attack. The additional sensors will detect bending or deformation of the side panel E in the area surrounding the sensor location caused, for example, by localised force or pressure applied to the panel E.

In order for the or each sensor F to generate an output, it is necessary for the surface to which the sensor F is attached to deflect, bend or distort from its natural datum, i.e. the condition which it occupies when no attack is taking place.

The or each sensor F is attached to the side panel E in such a way as to maximise the points of contact between the sensor F and the surface with which it is in contact. In addition, the or each sensor F is placed where the maximum number of lines of stress flux are to be found. In practice, it is usually necessary to smooth the surface prior to attachment of the or each sensor F using sandpaper. The preferred method of attachment of the or each sensor F to the surface is the use of a cyanoacrylate adhesive, i.e. a quick-drying resin.

The signal from the or each sensor F is fed to an electronic control circuit H, where it is amplified and filtered to remove the unwanted components of the signal prior to transmission of the signal to an alarm. The electronic control circuit is shown in FIG. 6.

The sensors are also suitable for detecting the effects of heat by someone trying to gain entry to the safe A using a flame-cutting torch or thermal lance as the deflection of the side panel E and/or sensor F caused by expansion due to the rapid change of temperature will also set off the alarm.

The sensors F are also suitable for detecting high-frequency noise or vibration induced into the side panel E in an area surrounding the location of the sensor F caused by the application of equipment such as a disc cutter, angle grinder or drill.

While the system shown in FIG. 2 is suitable for use in protecting the safe of, for example, an automatic teller machine (ATM), it is also possible to fit sensors on other surfaces either outside or inside the safe to increase the level of security.

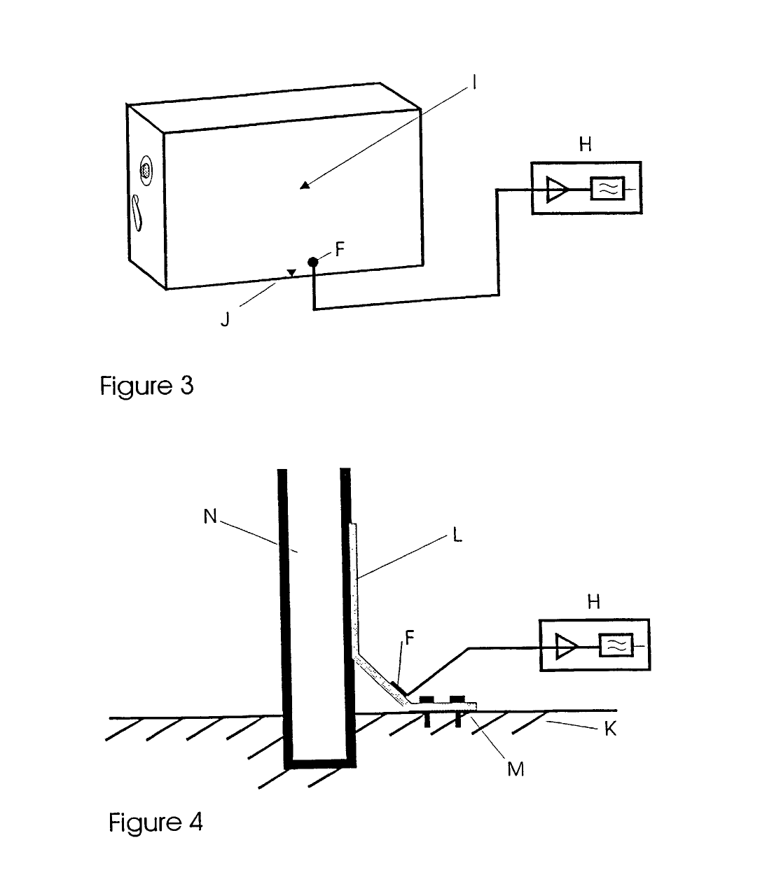

Thus, when the safe is part of an ATM installation, the degree of security can be enhanced by placing additional sensors in strategically located places, for example, on the side panel I of the main casing of the ATM installation, as shown in FIG. 3. In practice, it will normally be better to fit the sensor towards the edge of the panel I, as indicated by the point J, rather than in the centre of the panel I, as more deflection occurs at point J whereas more travel might occur at the centre of the panel I.

A further enhancement of the system is to fit a sensor in a position in which it will detect an attempt to gain access through a wall, as shown in FIG. 4. The wall is shown as N and the ground is K while L is a piece of resilient material which is bearing against the wall N and is under spring tension as a result of the fixings M which secure the piece of resilient material L to the ground K or any other suitable fixed point.

A sensor F is secured to the piece of resilient material L at a point in its length which is subject to the effects of the spring tension such that, if the wall N is forced inwards or pulled outwards or, indeed, if some masonry were to fall on the piece of resilient material L, any of these actions would cause the spring tension to change resulting in an output from the sensor F.

Alternatively, a sensor F is secured to a pre-fabricated bearer supporting the safe or ATM at a point close to the position of the bolts used to secure the bearer to the fixed floor or structure of the building in which the safe or ATM is located such that, if sufficient force is applied to up-root the safe or ATM from the floor or other fixed structure, the deformation of the bearer around the securing bolt will result in an output from the sensor.

In all cases, the or each sensor F is connected to the electronic control circuit H. In some instances, one or more sets or channels of the electronic control circuitry will be provided as it may be necessary to set the sensitivity of the wall or side panel circuits differently from that required for the safe.

Turning now specifically to FIG. 6, this shows the electronic control circuit to which signals are fed by the sensors F and which controls operation of an alarm. One sub-channel of the control circuit is set to a high level of sensitivity and has a low threshold to detect low amplitude signals caused by very minor deflections of the safe structure around the position of the sensor or sensors. These could be caused by something as little as a person or heavy object leaning or being pushed against the safe structure. This sub-channel is intended to provide an initial alert and includes a filter LPF, a low threshold amplifier and two gates indicated as GATE 1 and GATE 2.

A second sub-channel of the control circuit is set to a high threshold level to identify major deflections of the safe structure adjacent the sensor or sensors. Such deflections are likely to be caused by a savage attack on the structure of the safe or, more likely, by rapid heating of the side of the safe by means of an oxyacetylene torch or other cutting device. Use of such a device would initially be detected by the high-sensitivity “alert” sub-channel referred to above and then by this sub-channel. This sub-channel provides a follow-up to the initial alert with a full ALARM suggesting use of heat-based cutting equipment. It includes the filter LPF, a high threshold amplifier and the two gates indicated as GATE 1 and GATE 2.

A third and separate sub-channel of the control circuit includes a very high threshold detector LEVEL DET. This sub-channel can be linked to a separate sensor or sensors located on a resilient plate bearing against the wall or close to the mounting bolts for the automatic teller machine (ATM) to detect major deformations of the resilient plate or mounting bolts caused by attempts to, for example, uproot the ATM by force. Activation of this sub-channel represents a major attack on the ATM and activates an alarm. This sub-channel includes a filter LPF, the level detector LEVEL DET and GATE 2.

A fourth sub-channel of the control circuit looks for signals having a high frequency such as the noise signals which would be caused by an angle grinder or drill used to attack the wall of the ATM adjacent to a sensor or sensors. This fourth sub-channel is responsive to signals within the high frequency band which have an amplitude above a chosen threshold and either occur continuously for a pre-selected period of time or occur for a pre-set percentage of a pre-selected period of time. This fourth sub-channel includes filter HPF, the noise level detector, a timer, GATE 1 and GATE 2.

If a drill or angle grinder is placed against the ATM in the proximity of a sensor or sensors, the first sub-channel or ALERT will initially be activated. If the drill or angle grinder is then started, the fourth sub-channel will respond to the generated noise and follow up the initial alert with a full ALARM suggesting that a drill or angle grinder is being used to attack the ATM.

High frequency noises generated outside the immediate vicinity of the ATM will not normally cause an alarm because:

a) the noise signal must be accompanied by a deflection of the structure of the ATM,

b) the noise signal must be substantially continuous, and

c) the amplitude of the signal reaching the sensors is unlikely to be large enough to generate the alarm.

Although the invention has been described above with reference to a safe and an automatic teller machine, it will be appreciated that the sensor system can be used for other security applications. For example, a sensor may be attached to a sheet of reinforced glass in a window of a secure room such that any attempt to break the reinforced glass will result in operation of an alarm. A sensor might also be attached to the underside of a floor panel in a secure area so that any person treading on the floor panel will trigger the alarm.

1. A sensor system for security purposes, said sensor system comprising a piezo-electric device attached to a member in the line of stress flux such that unauthorised movement of the member will result in deflection of the piezo-electric device and generation of an electrical output which is passed to an electronic control circuit which includes filter means for separation of signals due to high-frequency events, which electronic control circuit is arranged to transmit a signal to an alarm, data processing device or other recording or indicating means.

2. A sensor system as claimed in claim 1, in which the electronic control circuit includes means for responding to both low-frequency and high-frequency events.

3. A sensor system as claimed in claim 1, in which the piezo-electric device includes a disc or other suitably shaped piezo device which is bonded to the member.

4. A sensor system as claimed in claim 3, in which the member is a panel of a safe, a panel of a housing of an ATM or a prefabricated bearer which is positioned so that any attempt to break down a wall or strong-room or to up-root a safe or an ATM will result in the application of stress to the prefabricated bearer and the generation of an output voltage.

5. A sensor system as claimed in claim 3, in which the piezo-electric device is bonded to the member in a deflected condition.

6. A sensor system as claimed in claim 3, in which bonding of the piezo-electric device to the member is effected using a quick-drying adhesive such as a cyanoacrylate adhesive.

7. A security system which includes:
a) a sensor system comprising a piezo-electric device attached to a member in the line of stress flux such that unauthorised movement of the member will result in deflection of the piezo-electric device and generation of an electrical output,
b) an electronic control circuit to which the electrical output is passed, the electronic control circuit including filter means for separation of signals due to high-frequency events, and
c) an alarm to which a signal is transmitted by the electronic control circuit.

8. A security system as claimed in claim 7, in which the electronic control circuit includes means for responding to both low-frequency and high-frequency events.

9. A security system as claimed in claim 8, in which the electronic control circuit is arranged, in pre-selected circumstances, to generate a signal corresponding to an “ALERT” prior to generation of a signal corresponding to an “ALARM”.
